(19) United States
(12) Patent Application Publication
(10) Pub. No.: US 2012/0050325 A1
(43) Pub. Date: Mar. 1, 2012

(54) SYSTEM AND METHOD FOR PROVIDING VIRTUAL REALITY LINKING SERVICE

(75) Inventors: Sang Hyun JOO, Daejeon (KR); Chang Joon PARK, Daejeon (KR); Byoung Tae CHOI, Daejeon (KR); Gil Haeng LEE, Seoul (KR); Young Jik LEE, Daejeon (KR)

(73) Assignee: Electronics and Telecommunications Research Institute, Daejeon (KR)

(21) Appl. No.: 13/216,846

(22) Filed: Aug. 24, 2011

(30) Foreign Application Priority Data
Aug. 24, 2010 (KR) 10-2010-0082071

(51) Int. Cl. G09G 5/377

(52) U.S. Cl. 345/633

(57) ABSTRACT

Provided is a terminal for providing a virtual reality linking service. The terminal providing a virtual reality linking service according to an exemplary embodiment of the present invention includes: a user information inputting unit receiving user information; a receiving unit receiving a virtual reality linking service including a sensory effect for each object and a rendering result corresponding to the user information; a real object characteristic information generating unit generating real object characteristic information by extracting a sensitive characteristic stimulating senses of people from a real object which really exists around the user; an object motion information generating unit generating object motion information by recognizing a physical motion of the real object; and a transmitting unit providing the user information, the real object characteristic information, and the object motion information.

### CROSS-REFERENCE TO RELATED APPLICATIONS

This application claims priority under 35 U.S.C. §119 to Korean Patent Application No. 10-2010-0082071, filed on Aug. 24, 2010, in the Korean Intellectual Property Office, the disclosure of which is incorporated herein by reference in its entirety.

### TECHNICAL FIELD

The present invention relates to a system and a method for providing a virtual reality linking service, and more particularly, to a system and a method for providing a virtual reality linking service which is a service merging reality and a virtual world.

### BACKGROUND

The known virtual reality linking technology generates a virtual object corresponding to a real object of a real world and expresses the generated virtual object in a virtual space to allow a user to enjoy a virtual reality. However, since the user cannot modify an object in the virtual reality on according to user's intention, the user cannot help using the virtual reality linking service as it is. Accordingly, the user cannot freely come and go to the real world and the virtual world by reconfiguring the virtual world as the user desires by using the known virtual reality linking technology.

### SUMMARY

An exemplary embodiment of the present invention provides a server for providing a virtual reality linking service, the server including: a receiving unit receiving at least one of user information for distinguishing the user from other users, real object characteristic information including information in which a sensitive characteristic stimulating senses of people is extracted from the real object, object motion information which is information regarding a motion of the real object, and set-up information for each object; a virtual space setting unit generating and setting a virtual space; a virtual object managing unit generating and managing at least one virtual object corresponding to the real object according to the real object characteristic information and the object motion information; a target object managing unit generating and managing at least one target object including the service which is providable to the user in the virtual space; a sensory effect managing unit generating and managing a sensory effect for each object corresponding to at least one of the virtual object and the target object; a sensory effect setting unit setting the sensory effect for each object of the sensory effect managing unit to be changed according to the set-up information for each object; a matching unit matching at least one of the virtual object and the target object to the virtual space by reflecting the sensory effect for each object; a rendering unit performing rendering according to the matching result; and a service generating unit generating a virtual reality linking service including the sensory effect for each object and the rendering result.

Another exemplary embodiment of the present invention provides a terminal for providing a virtual reality linking service, the terminal including: a user information inputting unit receiving user information for distinguishing the user from other users; a receiving unit receiving a virtual reality linking service including a sensory effect for each object and a rendering result corresponding to the user information; a real object characteristic information generating unit generating real object characteristic information by extracting a sensitive characteristic stimulating senses of people from a real object which really exists around the user; an object motion information generating unit generating object motion information by recognizing a physical motion of the real object; and a transmitting unit providing the user information, the real object characteristic information, and the object motion information.

Yet another exemplary embodiment of the present invention provides a method for providing a virtual reality linking service, the method including: receiving user information for distinguishing the user from other users; managing profiles including an avatar set-up information corresponding to the user information; generating an avatar object which is the other self in a virtual space according to the profiles; setting the virtual space; generating real object characteristic information including information in which a sensitive characteristic stimulating senses of people is extracted from a real object; generating object motion information which is information regarding a motion of the real object and set-up information for each object; receiving at least one of the real object characteristic information and the object motion information; generating at least one virtual object corresponding to the real object according to at least one of the real object characteristic information and the object motion information; generating at least one target object including a service which is providable to the user in the virtual space; generating a sensory effect for each object corresponding to at least one of the plurality of virtual objects, target objects, and avatar objects; setting the sensory effect for each object to be changed according to the set-up information for each object; matching at least one of the virtual object, the avatar object, and the target object to the virtual space by reflecting the sensory effect for each object; performing rendering according to a result of the matching; and generating a virtual reality linking service including the sensory effect for each object and the rendering result.

Other features and aspects will be apparent from the following detailed description, the drawings, and the claims.

### BRIEF DESCRIPTION OF THE DRAWINGS

FIG. 1 is a diagram showing a process of linking a real world and a virtual world with each other through an out & in service.

FIGS. 2 and 3 are procedural diagrams showing procedures performed by a virtual reality linking service providing server and a virtual reality linking service providing terminal according to an exemplary embodiment of the present invention.

FIG. 4 is a block diagram showing the structure of a virtual reality linking service providing server according to an exemplary embodiment of the present invention.

FIG. 5 is a block diagram showing the structure of a virtual reality linking service providing terminal according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

A method and a method for providing a virtual reality linking service according to exemplary embodiments of the present invention provide a virtual real linking service that allows a user to freely come and go to a real world and a virtual world by connecting the virtual world, the real world, and the user to one another and reconfigure a virtual space of a form which the user desires. Meanwhile, in the specification, for better comprehension and ease of description, the virtual reality linking service according to the present invention will be referred to as an out & in service.

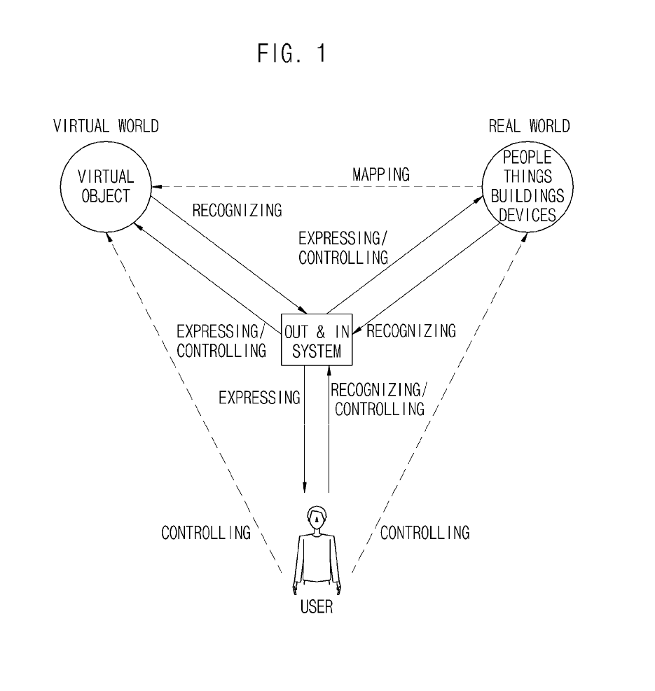

Hereinafter, referring to FIG. 1, an out & in service according to an exemplary embodiment of the present invention will be described.

FIG. 1 is a diagram showing a process of linking a real world and a virtual world with each other through an out & in service.

As shown in FIG. 1, a user may receive an out & in service in which the virtual world and the real world are linked with each other through the virtual reality linking service providing system (hereinafter, referred to as the “out & in system”) according to the exemplary embodiment of the present invention.

As described above, the out & in system provides an out & in service that connects a virtual world, a real world, and a user and allows the user to freely go and come to the real world and the virtual world by reconfiguring a virtual space as a form which the user desires. That is, the out & in system establishes the virtual space and generates virtual objects corresponding to people, things, buildings, devices, and the like which exist in the real world to construct the virtual world. The virtual objects may be recognized, expressed, and controlled through the out & in system and the user may reconfigure the virtual objects and the virtual space as the user desires by using the out & in system. Further, the out & in system expresses the virtual objects and the virtual space by using diverse control devices which are controllable in the real world.

Accordingly, the user can enjoy social activities in the virtual world by sharing the virtual space with other users through the out & in system. Since the user reconfigures a virtual object and the virtual space by freely modifying the virtual object as the user desires through the out & in system, the user can perform social activities in the virtual world of a form which the user desires.

Service components of the out & in system include a minor world technology mapping the real world to the virtual world, a virtual world recognizing technology linking services of the virtual world through the out & in system, a virtual world expressing and controlling technology inputting information in the virtual world or controlling the object through the out & in system, and a real world recognizing technology recognizing people, things, buildings, devices, and the like of the real world through the out & in system.

Further, the service components may include diverse technologies such as a real world expressing and controlling technology selecting, deleting, substituting, and controlling the people, the things, the buildings, and the devices of the real world or expressing additional information through the out & in system, an out & in system controlling technology, as the technology transferring a command which the user intends to the out & in system, controlling the virtual world or the real world by recognizing the user's command, an expressing technology for transferring information recognized in the virtual world or the real world to the user, a real world direct controlling technology controlling in which the user directly controls the people, things, buildings, and devices of the real world, a virtual world direct controlling technology in which the user directly controls an avatar, an object, and a simulation of the virtual world, and a common environment providing technology when each user accesses the service under diverse environments.

Meanwhile, the out & in system adopts a shared space multi-viewpoint rendering technology providing a common environment when each user accesses the service under diverse environments, a real-time streaming technology for synchronization by transferring information to the virtual world or the real world, a real-time synchronization technology for different users to interact with each other while sharing a common virtual space under diverse environments, a multi-modal interaction technology for interaction between different users, and a heterogeneous network based information collecting technology collecting information by using diverse communication networks.

Further, the out & in system includes diverse technologies such as multi-platform mergence service technology as the service technology in which users under different environments in their own platforms can access the virtual space on the out & in system, a technology of managing profile information regarding the avatar, object, and environment of the virtual world and the user, thing, device, and environment of the real world, a processing engine technology processing information input/output among the virtual world, the real world, and the user, a server technology for generating and managing the out & in system and the virtual space.

Hereinafter, a virtual reality linking service providing system and a virtual reality linking service providing method for specifically implementing the out & in system will be described with reference to the accompanying drawings.

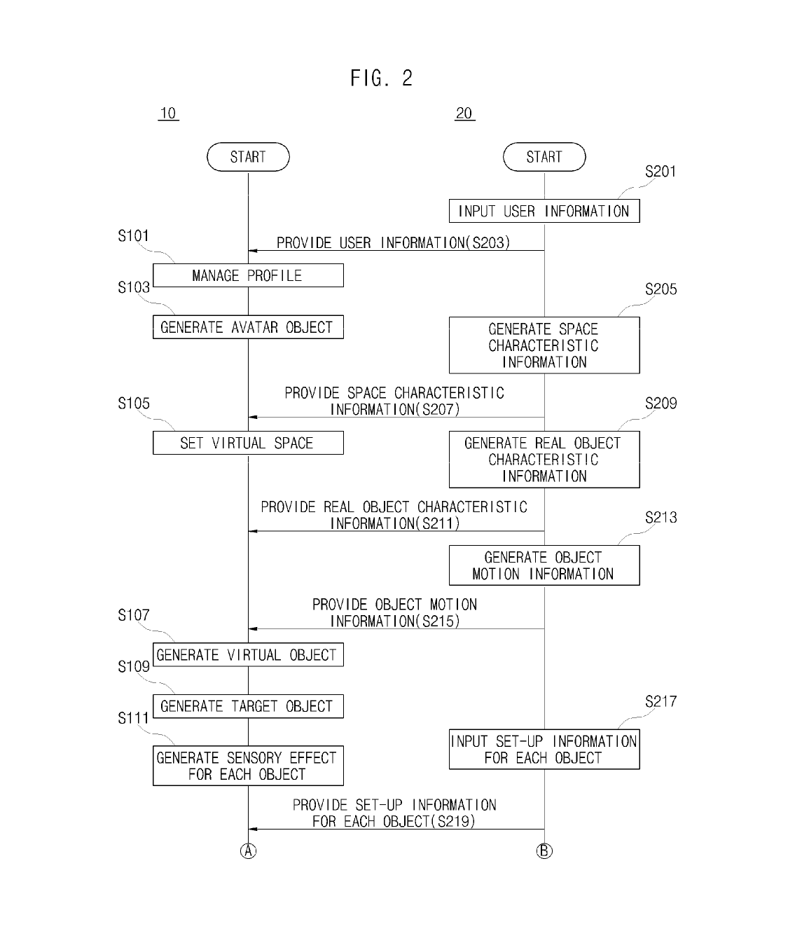

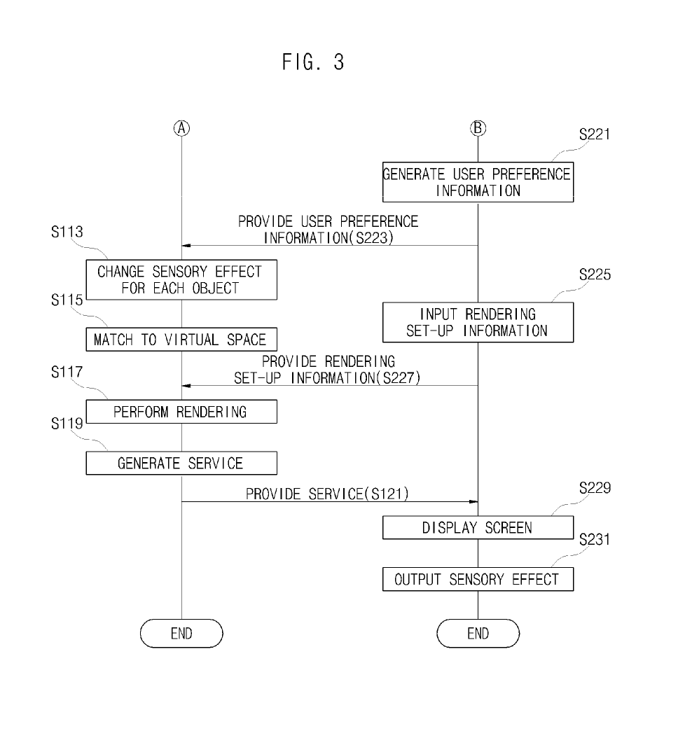

Referring to FIGS. 2 and 3, the virtual reality linking service providing system according to the exemplary embodiment of the present invention will be described. FIGS. 2 and 3 are procedural diagrams showing procedures performed by a virtual reality linking service providing server and a virtual reality linking service providing terminal according to an exemplary embodiment of the present invention.

The virtual reality linking service providing system for providing the out & in service includes a virtual reality linking service providing server (hereinafter, referred to as the “server”) 10 and a virtual reality linking service providing terminal (hereinafter, referred to as the “terminal”) 20.

The user inputs user information for distinguishing the user from other users through the virtual reality linking service providing terminal 20 (S201).

The terminal 20 provides the inputted user information to the server 10 (S203).

The server 10 manages profiles corresponding to the user information (S101).

Herein, the profile may include past service using history information regarding user's using the out & in service and includes avatar setting information to generate an avatar object which is a user's other self in the virtual space. Further, the profile may include user's personal information including user's personal information such as a tendency, a taste, sensibility, a medical history, and the like and user's surrounding information regarding users, things, devices, and environments of the real world around the user.

The profile may be used for the server 10 itself to generate user preference information depending on user preference and the user preference information may be used to generate, modify, and manage a sensory effect for each object corresponding to a virtual object, a target object, and an avatar object.

Thereafter, the server 10 generates the avatar object which is the other self in the virtual space according to the profile (S103) and establishes the virtual space (S105).

Herein, the virtual space, as a virtual physical space generated in the virtual reality linking service providing server 10, is a space where diverse objects such as the virtual object, the target object, and the avatar object, and the like are generated, arranged, and modified. The user experiences the virtual world in the virtual space corresponding to the real space.

Before the server 10 sets the virtual space, the terminal 20 generates space characteristic information including information associated with the usage of the space, indoor or outdoor, and luminance for a physical space around the user (S205) and the server 10 receives the space characteristic information from the terminal 20 to set the virtual space (S207).

For example, when the usage of the physical space around the user is a screen golf green, the server 10 may set a large virtual golf green as the virtual space.

Meanwhile, the terminal 20 may include an image collecting element and a sensor element such as a light receiving sensor, and the like in order to collect the space characteristic information and the server 10 may include a virtual space database (DB) storing the virtual space which can be set in the server 10 in order to set the virtual space.

The terminal 20 generates real object characteristic information including information in which a sensitive characteristic stimulating senses of people is extracted from real objects such as people, things, buildings, devices, and the like that exist in the real world (S209) and provides the real object characteristic information to the server 10 (S211).

Further, the terminal 20 generates object motion information which is information (e.g., information regarding a positional change, and the like depending on the motions of the real objects) regarding motions of the real objects (S213) and provides the object motion information to the server 10 (S215). Meanwhile, the terminal 20 may include sensor elements such as a motion sensor, a gravity sensor, and the like for collecting the information regarding the motions of the real objects.

Meanwhile, the real object characteristic information and the object motion information may be collected by analyzing 2D or 3D images.

Thereafter, the server 10 generates at least one virtual object corresponding to the real object according to at least one of the real object characteristic information and the object motion information (S107).

The virtual object is an object generated in the virtual space, which corresponds to the object in the real world. For example, when the user performs a swing operation with a golf club, the server 10 may generate a virtual golf club as the virtual object corresponding to the golf club which is the real object. In this case, the server 10 may generate the virtual golf club to which sensitive characteristics such as tactility, a shape, a color, and the like of the golf club are reflected by using the real object characteristic information and may generate the virtual golf club with which the same operation is performed from information regarding motions of the golf club by using the object motion information.

Meanwhile, the server 10 generates at least one target object for providing an additional service which can be provided to the user in the virtual space (S109).

Herein, the target object is generated to provide the additional service to the user in the virtual space.

For example, when the virtual space is set as a coffee shop, a menu for ordering coffees may be generated as the target object and the menu which is the target object may include an order-related service as the additional service.

The server 10 may include an additional service database (DB) storing the additional service which can be provided to the user in the virtual space as metadata and may be provided with an engine element such as a retrieval engine capable of retrieving the additional service, so as to generate the target object. Meanwhile, the target object is preferably generated according to a spatial characteristic in the virtual space.

Thereafter, the server 10 generates a sensory effect for each object corresponding to at least one of the plurality of virtual objects, target objects and avatar objects (S111).

The term of the sensory effect in the specification means an effect to stimulate any one sense of sight, touch, hearing, taste and smell of people respectively corresponding to the objects such as the virtual object, the target object, and the avatar object.

Meanwhile, the server 10 may use the profile, the user preference information, the real object characteristic information, and the object motion information in order to generate the sensory effect for each object.

Realistic characteristics of the corresponding virtual object, target object, and avatar object may be reflected to generation of the sensory effect for each object.

For example, when the real object is a cold square ice, the server 10 generates a square object as the virtual object and may generate the sensory effect for each object corresponding to the virtual object such as the tactility of the ice, sound when the ice is scratched, low temperature, and the like.

Meanwhile, the server 10 may include a sensory effect database DB including information regarding the sensory effect and control information of a sensory effect device in order to generate the sensory effect for each object.

Thereafter, the user inputs setting information for each object for setting up shapes, locations, and a sensory effect for each object of the virtual object, the target object, and the avatar object in the virtual space through the terminal 20 (S217) and the terminal 20 provides the set-up information for each object to the server 10 (S219).

Meanwhile, the user generates user reference information to which the user preference regarding the shape for each of the diverse objects and a sensory effect for each object is reflected through the terminal 20 (S221) and the terminal 20 provides the user preference information to the server 10 (S223).

Meanwhile, the server 10 may set the sensory effect for each object to be changed according to the set-up information for each object (S113). Further, the server 10 may set the sensory effect for each object corresponding to at least one of the virtual object, the target object, and the avatar object of a sensory effect manager 115 to be changed according to the user preference information to which the user preference regarding the shape for each of the diverse objects and the sensory effect for each object is reflected (S113).

Thereafter, the server 10 matches at least one of the virtual object, the avatar object, and the target object in the virtual space by reflecting the sensory effect for each object (S115).

Thereafter, the server 10 performs rendering according to a matching result in the virtual space (S117).

Meanwhile, the user inputs rendering set-up information including information for setting a resolution, a frame rate, a dimension, and the like for determining the level of rendering and the quality of a visual effect through the terminal 20 (S225) and the terminal 20 may provide the rendering set-up information to the server 10 (S227). In this case, the server 10 sets up the level of rendering according to the received rendering set-up information and may perform rendering according to the set-up level of rendering (S117).

Thereafter, the server 10 generates an out & in service including the sensory effect for each object and the rendering result (S119) and provides the out & in service to the terminal 20 (S121).

The terminal 20 displays the rendering result and the sensory effect on a screen by using the sensory effect for each object and the rendering result included in the received out & in service (S229) or outputs the rendering result and the sensory effect to a device capable of outputting the sensory effect for each object such as a realistic representation device (S231).

Meanwhile, the terminal 20 may retrieve the device capable of outputting the sensory effect for each object and output the sensory effect for each object by using the retrieved device.

Meanwhile, the out & in system is preferably provided with a real-time streaming technology for different users to transfer and synchronize information to the virtual world or real world under diverse environments.

Meanwhile, the out & in system should be able to use diverse communication networks in order to collect virtual object information and information associated with additional information by using diverse communication networks. For example, the virtual object information and the information associated with the additional information may be collected by adopting various kinds of communication types such as 3G, Wibro, WiFi, and the like.

Meanwhile, the out & in system may be provided in various forms so that each user can access the out & in system by using platforms of different environments. For example, the users may share the virtual space by accessing the out & in system in diverse platforms such as a smart terminal, a PC, an IP TV, and the like and interact with the virtual objects in real time.

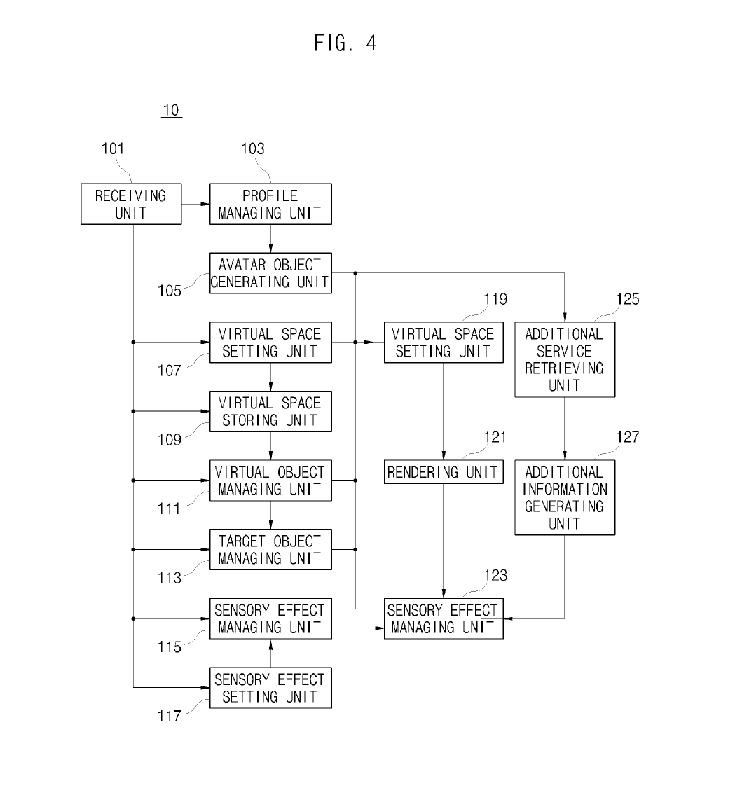

Referring to FIG. 4, the virtual reality linking service providing server for providing the out & in service according to the exemplary embodiment of the present invention will be described. FIG. 4 is a block diagram showing the structure of a virtual reality linking service providing server according to an exemplary embodiment of the present invention.

Referring to FIG. 4, the virtual reality linking service providing server 10 according to the exemplary embodiment of the present invention includes a receiving unit 101, a profile managing unit 103, an avatar object generating unit 105, a virtual space setting unit 107, a virtual space storing unit 109, a virtual object managing unit 111, a target object managing unit 113, a sensory effect managing unit 115, a sensory effect setting unit 117, a matching unit 119, a rendering unit 121, a service generating unit 123, an additional service retrieving unit 125, and an additional information generating unit 127.

The receiving unit 101 receives all information required to generate the out & in service from the virtual reality linking service providing server 10 according to the exemplary embodiment of the present invention.

The information received by the receiving unit 101 may include user information for distinguishing the user from other users, real object characteristic information including information in which a sensitive characteristic stimulating senses of people is extracted from the real object, object motion information which is information regarding motions of the real object, and set-up information for each object for setting up the shapes and locations of diverse objects in the virtual space, and the sensory effect for each object. Herein, the set-up information for each object includes at least one of virtual object setting information for setting the virtual object, target object setting information for setting the target object, and avatar object setting information for setting the avatar object.

Further, the user preference information to which the user preference associated with the shape for each of the diverse objects and the sensory effect for each object is reflected, object registration information for adding or deleting at least one of the virtual object and the target object in the virtual space of the out & in service, rendering set-up information for setting up the level of rendering, and spatial characteristic information regarding a real physical spatial characteristic may be provided according to the purpose of the use of the virtual reality linking service providing server 10.

The profile managing unit 103 manages at least one profile corresponding to the user information.

The avatar object generating unit 105 generates and manages the avatar object which is the other self in the virtual space of the user according to the avatar set-up information.

The virtual space setting unit 107 generates and sets the virtual space.

The virtual space storing unit 109 stores, and maintains and manages the virtual space.

The virtual object managing unit 111 generates and manages at least one virtual object corresponding to the real object according to the real object characteristic information and the object motion information.

The target object managing unit 113 generates and manages at least one target object for providing an addition service which can be provided to the user in the virtual space.

Meanwhile, the virtual object managing unit 111 and the target object managing unit 113 may manage at least one of the virtual object and the target object through addition or deletion according to the object registration information.

The sensory effect managing unit 115 generates and manages the sensory effect for each object corresponding to at least one of the virtual object, the target object, and the avatar object.

The sensory effect setting unit 117 sets the sensory effect for each object corresponding to at least one of the virtual object, the target object, and the avatar object of the sensory effect managing unit 115 to be changed according to the set-up information for each object corresponding to at least one of the virtual object, the target object, and the avatar object.

Thereafter, the matching unit 119 matches at least one of the virtual object, the avatar object, and the target object in the virtual space by reflecting the sensory effect for each object (S115).

The rendering unit 121 performs rendering according to the matching result.

The service generating unit 123 generates the out & in service which is the virtual reality linking service including the sensory effect for each object and the rendering result.

The additional service retrieving unit 125 retrieves the additional service information which can be provided to the user associated with the target object.

The additional information generating unit 127 generates additional information corresponding to each target object according to the additional service information retrieved by the service retrieving unit 125. Herein, the additional information includes interface information providing an input element so as to receive the additional service. In this case, the service generating unit 123 further includes the additional information to generate a virtual reality linking service.

That is, the additional information is generated by processing the additional service information so as to provide the additional service included in the target object to the user through the virtual reality linking service.

For example, when the coffee shop is set as the virtual space and the menu which is the target object including the order-related service as the additional service is generated, the additional information includes the interface information and details information of the addition service to receive the order-related service.

Meanwhile, the virtual space setting unit 107 selects one of a plurality of virtual spaces stored in the virtual space storing unit to set the virtual space. Accordingly, the user may reuse the virtual space which the user uses and the user may use the stored virtual space by calling the corresponding virtual space through the virtual space setting unit 107.

Further, the virtual space setting unit 107 may set the virtual space by using the space characteristic information. The space characteristic information may include information associated with the usage of the space, indoor or outdoor, and luminance for a physical space around the user.

Further, the sensory effect setting unit 117 may set the sensory effect for each object corresponding to at least one of the virtual object, the target object, and the avatar object of a sensory effect manager 115 to be changed according to the user preference information to which the user preference regarding the shape for each of the diverse objects and the sensory effect for each object is reflected.

The user preference information may be generated through analyzing the user preference by using past service using history information, user's personal information, and user's surrounding information from the profile corresponding to the user information. Further, the user preference information may be provided through the receiving unit 101.

Meanwhile, the virtual object managing unit 111 sets the virtual object to be changed in its shape according to the virtual object set-up information to manage the virtual object. Similarly, the target object managing unit 113 sets the target object to be changed in its shape according to the target object set-up information to manage the target object.

Accordingly, the sensory effect setting unit 117 sets the sensory effect for each object to be changed, while the virtual object managing unit 111 and the target object managing unit 113 may set and manage the virtual object and target object to be changed in their own shapes.

Meanwhile, the rendering unit 121 sets the level of rendering according to the rendering set-up information and may perform rendering according to the level of rendering. In this case, the rendering set-up information may include information for setting a resolution, a frame rate, a dimension, and the like for determining the level of rendering and the quality of a visual effect.

Meanwhile, the rendering unit 121 may perform multi-viewpoint rendering.

Accordingly, when each user accesses the service under diverse environments, the rendering unit 121 may perform rendering so that each user has different viewpoints in the different virtual spaces.

Meanwhile, since a plurality of users share the virtual space and diverse object information should be able to be generated and managed, the virtual reality linking service providing server 10 may simultaneously manage the number of persons who simultaneously access the service and the virtual space and perform real-time processing for the streaming service.

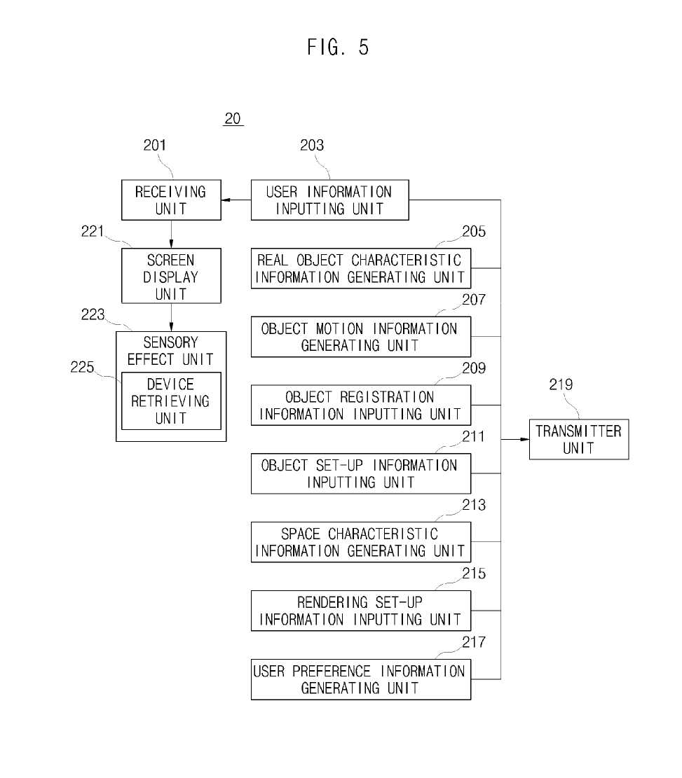

Referring to FIG. 5, a virtual reality linking service providing terminal for providing the out & in service according to the exemplary embodiment of the present invention will be described. FIG. 5 is a block diagram showing the structure of a virtual reality linking service providing terminal according to an exemplary embodiment of the present invention.

Referring to FIG. 5, the virtual reality linking service providing terminal 20 according to the exemplary embodiment of the present invention includes a receiving unit 201, a user information inputting unit 203, a real object characteristic information generating unit 205, an object motion information generating unit 207, an object registration information inputting unit 209, a space characteristic information generating unit 213, a rendering set-up information inputting unit 215, a user preference information generating unit 217, a transmitting unit 219, a screen display unit 221, and a sensory effect unit 223.

The receiving unit 201 receives the virtual reality liking service including the sensory effect for each object and the rendering result corresponding to the user information.

The user information inputting unit 203 receives user information for distinguishing the user from other users.

The real object characteristic information generating unit 205 extracts sensitive characteristics stimulating senses of people from a real object which actually exists around the user to generate real object characteristic information.

The object motion information generating unit 207 recognizes a physical motion of the real object to generate object motion information.

The object registration information inputting unit 209 receives object registration information for adding or deleting at least one of the virtual object and the target object used in the virtual reality linking service from the user.

The object set-up information inputting unit 211 receives from the user set-up information for each object including at least one of virtual object set-up information for setting the virtual object used in the virtual reality linking service, target object set-up information for setting the target object, and avatar object set-up information for setting the avatar object.

The space characteristic information generating unit 213 recognizes the physical space around the user to extract a characteristic depending on at least one of the usage of the space, indoor or outdoor, and luminance, thereby generating the space characteristic information.

The rendering set-up information inputting unit 215 receives rendering set-up information for setting the level of rendering for determining the quality of visualization information from the user.

The user preference information generating unit 217 generates user preference information to which user preference for a sensory effect for each object corresponding to at least one of the virtual object, the target object, and the avatar object used in the virtual reality linking service is reflected.

The transmitting unit 219 provides the user information, real object characteristic information, object motion information, object registration information, object set-up information, space characteristic information, rendering set-up information, and user preference information to the server 10.

The screen display unit 221 displays the rendering result and sensory effect for each object on a screen.

The sensory effect unit 223 outputs the sensory effect for each object to a device capable of outputting the sensory effect for each object such as a realistic representation device.

Meanwhile, the sensory effect unit 223 includes a device retrieving unit 225 that retrieves the device capable of outputting the sensory effect for each object and outputs the sensory effect for each object by using the device retrieved by the device retrieving unit 225.

Accordingly, through the above-mentioned out & in system, the user receives the out & in system and may remove or substitute or reconfigure people, things, buildings, and devices which exist in a real environment.

For example, the user may change the other party's face to a face of an entertainer whom the user likes when talking with a disagreeable person by using the out & in system. Accordingly, the user may talk with the other party while seeing the face of the entertainer whom the user likes and hearing the voice of the entertainer through the out & in system.

Further, the user may change and use an interface of a device which exists in the real environment into a mode which the user prefers through the out & in system.

For example, in the case of an audio device having a complicated interface, even when the user is a child or the old, an interface of the audio device may be changed to a simple interface displayed to have only a simple function so that the child or old can easily operate the interface.

The user may select his/her own avatar and interact with other avatars or objects through the out & in system.

For example, in the case in which there are present a teacher who lectures and students who attend the lecture in an offline classroom and there are students who do not attend the lecture because they are sick or due to a problem in distance, the students who do not attend the lecture take lessons in the virtual world. They use a service to freely make a query and an answer each other by using the out & in system.

In addition, a method of using the out & in system is diversified.

For example, golfers who are in a real-world gold game, a screen golf, and a game golf environment may play a golf game together with each other in a golf out & in space providing a multi-user golf service. In this case, information regarding a wind speed, a green condition, and the like for a real-world golf green is transferred to the screen golf and the game golf and golfers in the real world and the virtual world may share information regarding a golf course and the other golfers through the out & in. Further, a golf coach may advise game participants while seeing the game through the golf out & in space.

When the user talks with the other party through the out & in system, the user may change the appearance and the way of speaking of the other party, and a surrounding environment as the user desires.

Further, when the user uses the coffee shop through the out & in system, the user changes an interior and an appearance of a shop assistant in the virtual space to a form which the user desires and may receive a service to perform order and payment at once.

A remote dance service in which real-world dancers who are physically apart from each other may dance together in a virtual space may be provided through the out & in system. Accordingly, dancers who are positioned in physically different regions meet with each other in the virtual space through the out & in system to overcome a geographical limit and dance together, thereby expecting an entertainment effect.

Further, an on/off line integration conference service may be provided through the out & in service. Accordingly, a virtual avatar participates in a real conference without distinguishing the real world from the virtual world and real people participate in the virtual world conference to overcome a spatial limit and an open type conference environment in which anybody can participate in the conference can be constructed.

As described above, the method of using the out & in service using the out & in system may adopt diverse methods other than the above-mentioned method and may be changed according to circumstances.

According to exemplary embodiments of the present invention, there are provided a system and a method for providing a virtual reality linking service that connects a virtual world, a real world, and a user, and allows the user to freely go and come to the real world and the virtual world by reconfiguring a virtual space as a form which the user desires.

Accordingly, the user can enjoy social activities in the virtual world by sharing the virtual space with other users through the virtual reality linking service providing system. Since the user reconfigures a virtual object and the virtual space by freely modifying the virtual object as the user desires through the virtual reality linking service providing system, the user can perform social activities in the virtual world of a form which the user desires.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A server for providing a virtual reality linking service, comprising:
a receiving unit receiving at least one of user information, real object characteristic information including sensitive characteristic information of a real object, motion information of a real object, and set-up information for each object;
a virtual space setting unit generating and setting a virtual space;
a virtual object managing unit generating and managing at least one virtual object corresponding to the real object according to the real object characteristic information and the object motion information;
a target object managing unit generating and managing at least one target object for providing an additional service which is providable to the user in the virtual space;
a sensory effect managing unit generating and managing a sensory effect for each object corresponding to at least one of the virtual object and the target object;
a sensory effect setting unit setting the sensory effect for each object of the sensory effect managing unit to be changed according to the set-up information for each object;
a matching unit matching at least one of the virtual object and the target object to the virtual space;
a rendering unit performing rendering according to the matching result; and
a service generating unit generating a virtual reality linking service including the sensory effect for each object and the rendering result.

2. The server of claim 1, further comprising:
a profile managing unit managing at least one profile including avatar set-up information corresponding to the user information; and
an avatar object generating unit generating and managing an avatar object which is the other self in a virtual space of the user according to the avatar set-up information,
wherein the sensory effect managing unit additionally generates and manages the sensory effect for each object corresponding to the avatar object and the matching unit additionally matches the avatar object to the virtual.

3. The server of claim 1, wherein the set-up information for each object includes object set-up information for setting a shape, a location, and a sensory effect for each object of at least one of the virtual object and the target object in the virtual space, respectively.

4. The server of claim 3, wherein the target object managing unit manages the target object by setting at least one of the shape and the location of the target object in the virtual space to be changed according to the object set-up information.

5. The server of claim 3, wherein the virtual object managing unit manages the virtual object by setting at least one of the shape and the location of the virtual object in the virtual space to be changed according to the object set-up information.

6. The server of claim 1, further comprising:
an additional service retrieving unit retrieving additional service information which is providable to the user associated with the target object; and
an additional information generating unit generating additional information corresponding to each target object according to the additional service information retrieved by the service retrieving unit,
wherein the service generating unit further includes the additional information to generate the virtual reality linking service.

7. The server of claim 1, wherein the receiving unit further receives object registration information for adding or deleting at least one of the virtual object and the target object, and
the virtual object managing unit and the target object managing unit manages the virtual object and the target object by adding or deleting at least one of the virtual object and the target object according to the object registration information.

8. The server of claim 1, wherein the receiving unit further receives rendering set-up information for setting the level of the rendering, and
the rendering unit sets the level of the rendering according to the rendering set-up information and performs the rendering according to the level of the rendering.

9. The server of claim 1, wherein the receiving unit further receives space characteristic information for a characteristic of a physical space, and
the virtual space setting unit sets the virtual space by using the space characteristic information.

10. A terminal for providing a virtual reality linking service, comprising:
a user information inputting unit receiving user information;
a receiving unit receiving a virtual reality linking service including a sensory effect for each object and a rendering result corresponding to the user information;
a real object characteristic information generating unit generating real object characteristic information by extracting a sensitive characteristic stimulating senses of people from a real object which really exists around the user;
an object motion information generating unit generating object motion information by recognizing a physical motion of the real object; and
a transmitting unit providing the user information, the real object characteristic information, and the object motion information.

11. The terminal of claim 10, further comprising:
an object registration information inputting unit receiving object registration information for adding or deleting at least one of a virtual object and a target object used in the virtual reality linking service from a user,
wherein the transmitting unit further provides the object registration information.

12. The terminal of claim 10, further comprising:
an object set-up information inputting unit receiving set-up information for each object including object set-up information for setting at least one of a virtual object, a target object, and an avatar object used in the virtual reality linking service from a user,
wherein the transmitting unit further provides the object set-up information.

13. The terminal of claim 10, further comprising:
a space characteristic information generating unit generating space characteristic information by extracting a characteristic depending on at least one of the usage of the space, indoor or outdoor, and illuminance by recognizing a physical space around the user,
wherein the transmitting unit further provides the space characteristic information.

14. The terminal of claim 10, further comprising:
rendering set-up information inputting unit receiving from a user rendering set-up information for setting the level of rendering for determining the quality of the visualization information,
wherein the transmitting unit further provides the rendering set-up information.

15. The terminal of claim 10, further comprising a screen display unit displaying a result of the rendering on a screen.

16. The terminal of claim 10, further comprising a sensory effect unit outputting the sensory effect for each object.

17. The terminal of claim 16, wherein the sensory effect unit includes a device retrieving unit retrieving a device capable of outputting the sensory effect for each object and outputs the sensory effect for each object by using the device retrieved by the device retrieving unit.

18. The terminal of claim 10, further comprising:
a user preference information generating unit generating user preference information to which user preference for a sensory effect for each object corresponding to at least one of the virtual object, the target object, and the avatar object used in the virtual reality linking service is reflected,
wherein the transmitting unit further provides the user preference information.

19. A method for providing a virtual reality linking service, comprising:
receiving user information;
generating an avatar object which is the other self in a virtual space corresponding to the user information;
setting the virtual space;
generating real object characteristic information by extracting a sensitive characteristic from a real object;
generating object motion information which is information regarding a motion of the real object and set-up information for each object;
receiving at least one of the real object characteristic information and the object motion information;
generating at least one virtual object corresponding to the real object according to at least one of the real object characteristic information and the object motion information;
generating at least one target object for providing an additional service which is providable to the user in the virtual space;
generating a sensory effect for each object corresponding to at least one of the plurality of virtual objects, targets objects, and avatar objects;
setting the sensory effect for each object to be changed according to the set-up information for each object;
matching at least one of the virtual object, the avatar object, and the target object to the virtual space;
performing rendering according to a result of the matching; and
generating a virtual reality linking service including the sensory effect for each object and the rendering result.

20. The method of claim 19, wherein the set-up information for each object includes at least one of virtual object set-up information for setting the virtual object, target object set-up information for setting the target object, and avatar object set-up information for setting the avatar object.
